(19) United States
(12) Patent Application Publication
(10) Pub. No.: US 2014/0334431 A1
(43) Pub. Date: Nov. 13, 2014

(54) RADIO NETWORK CHANNEL ALLOCATION METHOD, DEVICE AND SYSTEM

(71) Applicant: HUAWEI TECHNOLOGIES CO., LTD., Shenzhen (CN)

(72) Inventors: Mingyu ZHOU, Shenzhen (CN); Qiang Wu, Beijing (CN)

(73) Assignee: HUAWEI TECHNOLOGIES CO., LTD., Shenzhen (CN)

(21) Appl. No.: 14/445,395

(22) Filed: Jul. 29, 2014

Related U.S. Application Data
(63) Continuation of application No. PCT/CN2013/071122, filed on Jan. 30, 2013.

(30) Foreign Application Priority Data
Jan. 30, 2012 (CN) 201210021096.0

(51) Int. Cl. H04W 72/04; H04L 1/00

(52) U.S. Cl. CPC H04W 72/04; H04L 1/0027
USPC 370/329

(57) ABSTRACT

Embodiments of the present invention provide a radio network channel allocation method, a device, and a system that relate to the communications field, so as to avoid that different UEs in a DAS cell occupy the same physical resources to send control signals, and enhance performance of a network side device in detecting the control signals sent by the UEs. The method includes: grouping user equipments UEs within a distributed antenna system DAS cell in a non-repeated manner; sending different cyclic shift value offset information to UEs in different groups, so that the UEs generate control signals according to the cyclic shift value offset information and send the control signals; and determining cyclic shift values used by the UEs according to the cyclic shift value offset information, and detecting the control signals sent by the UEs according to the cyclic shift values.

### CROSS-REFERENCE TO RELATED APPLICATIONS

This application is a continuation of International Application No. PCT/CN2013/071122, filed on Jan. 30, 2013, which claims priority to Chinese Patent Application No. 201210021096.0, filed on Jan. 30, 2012, both of which are hereby incorporated by reference in their entireties.

### TECHNICAL FIELD

The present invention relates to the field of radio communications, and in particular, to a radio network channel allocation method, a device, and a system.

### BACKGROUND

In a traditional radio communications system, generally, each user equipment (UE, User Equipment) only communicates with one node having a transmitting and receiving apparatus, where one node may correspond to one or more antennas, and only cover one geographic area correspondingly. The node may be a base station (Base Station, BS), an access point (Access Point, AP), a remote radio equipment (Remote Radio Equipment, RRE), a remote radio head (Remote Radio Head, RRH), a remote radio unit (Remote Radio Unit, RRU), and the like. In the traditional radio communications system, one cell only has one node. A network side device may allocate a different frequency band to each UE, and then the UE acquires a different cyclic shift value according to a number of the frequency band, so as to ensure that the UEs use different physical resources to send generated control signals. Different physical resources are orthogonal with each other; therefore, different physical resources used by different UEs have very small mutual interference.

With the development of technologies, people propose a distributed antenna system (DAS, Distributed Antenna System), that is, one cell includes nodes at multiple geographic positions; specifically, one cell includes multiple nodes, and these nodes are located at different geographic positions. However, as one cell includes multiple nodes, and different UEs may send signals to different nodes, the network side device may allocate the same frequency band to different UEs. If the prior art is used, different UEs may acquire the same cyclic shift value, and at this time, different UEs send the generated control signals by using the same orthogonal physical resources, causing mutual interference between the control signals generated by different UEs; as a result, the network side device is incapable of detecting the control signals sent by the UEs.

### SUMMARY

Embodiments of the present invention provide a radio network channel allocation method, a device, and a system, so as to avoid that different UEs occupy the same physical resources to send control signals, and therefore enhance performance of a network side device in detecting the control signals sent by the UEs.

In order to achieve the above objectives, an embodiment of the present invention adopts the following technical solution:

In an aspect, an embodiment of the present invention provides a radio network channel allocation method, including:

grouping user equipments UEs within a distributed antenna system DAS cell in a non-repeated manner;

sending different cyclic shift value offset information to UEs in different groups, so that the UEs generate control signals according to the cyclic shift value offset information and send the control signals; and

determining cyclic shift values used by the UEs according to the cyclic shift value offset information, and detecting the control signals sent by the UEs according to the cyclic shift values.

Another embodiment of the present invention provides a radio network channel allocation method, including:

receiving cyclic shift value offset information used for generating a control signal;

determining a cyclic shift value according to a cyclic shift offset value acquired from the cyclic shift value offset information; and

generating a control signal according to the cyclic shift value, and sending the control signal.

In another aspect, an embodiment of the present invention provides a network side device, including:

a grouping unit, configured to group user equipments UEs within a distributed antenna system DAS cell in a non-repeated manner;

a sending unit, configured to send different cyclic shift value offset information to UEs in different groups, so that the UEs generate control signals according to the cyclic shift value offset information and send the control signals; and

a detecting and receiving unit, configured to determine cyclic shift values used by the UEs according to the cyclic shift value offset information, and detect the control signals sent by the UEs according to the cyclic shift values.

An embodiment of the present invention provides a UE, including:

a receiving unit, configured to receive cyclic shift value offset information used for generating a control signal;

a calculation unit, configured to determine a cyclic shift value according to a cyclic shift offset value acquired from the cyclic shift value offset information; and

an information processing and sending unit, configured to generate a control signal according to the cyclic shift value, and send the control signal.

In still another aspect, an embodiment of the present invention provides a radio network system, including:

a network side device, configured to group user equipments UEs within a distributed antenna system DAS cell in a non-repeated manner; configured to send different cyclic shift value offset information used for generating a control signal to UEs in different groups, so that the UEs generate control signals according to the cyclic shift value offset information and send the control signals; and configured to determine cyclic shift values used by the UEs according to the cyclic shift value offset information, and detect the control signals sent by the UEs according to the cyclic shift values; and

a UE, configured to receive cyclic shift value offset information used for generating a control signal; configured to determine a cyclic shift value according to a cyclic shift offset value acquired from the cyclic shift value offset information; and configured to generate a control signal according to the cyclic shift value, and send the control signal.

The embodiments of the present invention provide a radio network channel allocation method, a device, and a system, so that UEs use different cyclic shift values to generate control signals, thereby avoiding that different UEs occupy the same physical resources to send control signals, and enhancing performance of a network side device in detecting the control signals sent by the UEs.

### BRIEF DESCRIPTION OF DRAWINGS

To illustrate the technical solutions according to the embodiments of the present invention more clearly, the following briefly introduces accompanying drawings required for describing the embodiments or the prior art. Apparently, the accompanying drawings in the following descriptions merely show some of the embodiments of the present invention, and persons of ordinary skill in the art can obtain other drawings according to the accompanying drawings without creative efforts.

FIG. 1 is a schematic flow chart of a radio network channel allocation method according to an embodiment of the present invention;

FIG. 2 is a schematic flow chart of another radio network channel allocation method according to an embodiment of the present invention;

FIG. 3 is a schematic flow chart of a radio network channel allocation method according to another embodiment of the present invention;

FIG. 4 is a schematic diagram of a use state of a cyclic shift value according to an embodiment of the present invention;

FIG. 5 is a schematic structural diagram of a network side device according to an embodiment of the present invention;

FIG. 6 is a schematic structural diagram of a UE according to an embodiment of the present invention; and

FIG. 7 is a schematic structural diagram of a radio network system according to an embodiment of the present invention.

### DESCRIPTION OF EMBODIMENTS

The technical solutions of the present invention will be clearly described in the following with reference to the accompanying drawings. It is obvious that the embodiments to be described are only a part rather than all of the embodiments of the present invention. All other embodiments obtained by persons of ordinary skill in the art based on the embodiments of the present invention without creative efforts shall fall within the protection scope of the present invention.

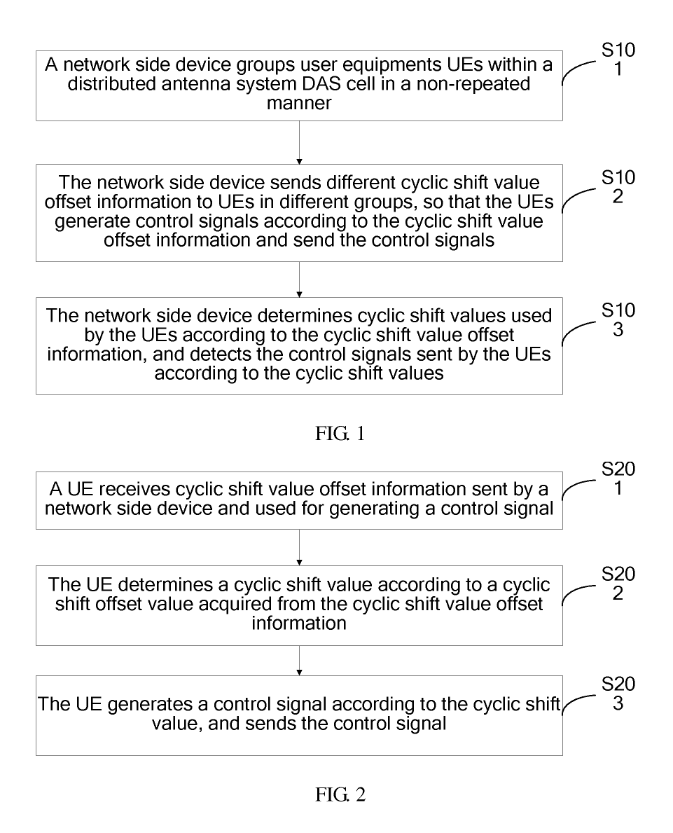

As shown in FIG. 1, at a side of a network side device, a radio network channel allocation method according to an embodiment of the present invention includes the following steps.

S101: A network side device groups user equipments UEs within a distributed antenna system DAS cell in a non-repeated manner.

Alternatively, the network side device may detect mutual interference strength among signals received from the UEs within the DAS cell, and group the UEs within the DAS cell in a non-repeated manner according to the mutual interference strength; UEs with mutual interference strength exceeding a preset threshold value are grouped into different groups.

S102: The network side device sends different cyclic shift value offset information to UEs in different groups, so that the UEs generate control signals according to the cyclic shift value offset information and send the control signals.

The control signal includes a physical uplink control channel (PUCCH, physical uplink control channel) signal, namely, a signal transmitted in the physical uplink control channel.

Alternatively, the network side device specifically sends different cyclic shift value offset information for controlling the physical uplink control channel to the UEs in different groups in a unicast or multicast manner.

Meanwhile, alternatively, the network side device sends different cyclic shift value offset information for controlling the physical uplink control channel to the UEs in different groups by using radio resource control RRC signaling and/or implicit signaling.

S103: The network side device determines cyclic shift values used by the UEs according to the cyclic shift value offset information, and detects the control signals sent by the UEs according to the cyclic shift values.

At a UE side, as shown in FIG. 2, the method includes the following steps:

S201: A UE receives cyclic shift value offset information sent by a network side device and used for generating a control signal.

In the same manner, alternatively, the UE may receive the cyclic shift value offset information used for generating a control signal in a unicast or multicast manner.

S202: The UE determines a cyclic shift value according to a cyclic shift offset value acquired from the cyclic shift value offset information.

S203: The UE generates a control signal according to the cyclic shift value, and sends the control signal.

According to a radio network channel allocation method provided in the embodiments of the present invention, UEs use different cyclic shift values to generate control signals, thereby avoiding that different UEs occupy the same physical resources to send control signals, and enhancing performance of a network side device in detecting the control signals sent by the UEs.

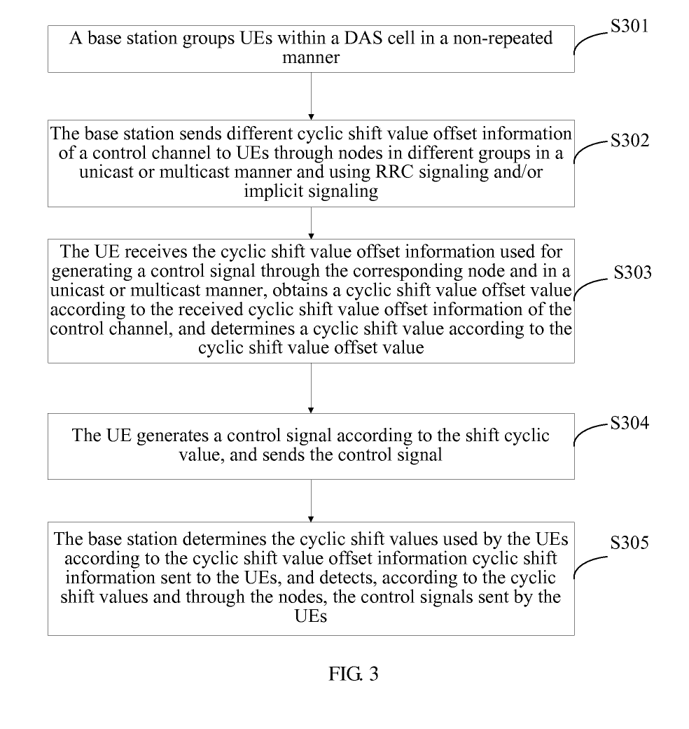

Specifically, a DAS cell in which a base station and multiple nodes are used as a network side device is taken as an example for detailed description. The specific process is shown in FIG. 3.

S301: A base station groups UEs within a DAS cell in a non-repeated manner.

Alternatively, the base station may detect mutual interference strength among signals received from the UEs within the DAS cell through the nodes, and group the UEs within the DAS cell in a non-repeated manner according to the mutual interference strength; UEs with mutual interference strength exceeding a preset threshold value are grouped into different groups. Certainly, the interference strength herein may refer to interference power or an interference voltage. Within the DAS cell herein, the base station is involved in a communication relationship with the UEs through the nodes, so the grouping of the UEs may employ the following method: grouping the UEs in a non-repeated manner according to nodes capable of detecting the control signals sent by the UEs.

S302: The base station sends different cyclic shift value offset information of a control channel to UEs through the nodes in different groups in a unicast or multicast manner and using RRC signaling and/or implicit signaling.

The unicast manner is specifically as follows: the base station sends CS offset information to each UE, where CS_{offset} carried in the CS offset information sent to the UEs in the same group is the same, and CS_{offset} carried in the CS offset information sent to UEs in different groups is different. The multicast manner is specifically as follows: the base station sends group information (such as a group number) to the UEs, and the UEs read the CS offset information sent by the base station to each group according to the received group information, so as to acquire a CS_{offset} value carried therein.

At this time, the base station may send the CS offset information to the UE through the RRC signaling; or particularly, the base station may also transmit signaling of the CS offset information to the UE through the implicit signaling. For example, the base station sends downlink reference signal (RS, Reference Signal) information to the UE, and the UE acquires the CS_{offset} value according to the RS information. For example, the cell includes a node 3 and a node 4. The base station sends RS information to a first group of UEs through the node 3 (certainly, the RS information may also be sent through the node 4), instructing the UEs to detect a downlink RS by using RS configuration with a sequence number of 1; the UEs then determine that the CS_{offset} value is 1 according to the RS information. The base station sends RS information to a second group of UEs through the node 4 (certainly, the RS information may also be sent through the node 3), instructing the UEs to detect the downlink RS by using RS configuration with a sequence number of 2; the UEs then determine that the CS_{offset} value is 2 according to the RS information.

S303: The UE receives the cyclic shift value offset information used for generating a control signal through the corresponding node and in a unicast or multicast manner, acquires a cyclic shift value offset value according to the received cyclic shift value offset information of the control channel, and determines a cyclic shift value according to the cyclic shift value offset value.

Technical personnel can easily understand that the specific implementation manner for the UE to receive the cyclic shift value offset information of the control channel in a unicast or multicast manner includes: using a unicast manner, in which the network side device encodes a data packet including the cyclic shift value offset information of the control channel by using a unique identity (such as a UE ID) corresponding to the UE, and sends the encoded data packet to the UE so that the UE can use the corresponding unique identity to identify the cyclic shift value offset information of the control channel sent by the network side device thereto; and using a multicast manner, in which the network side device first determines a multicast group where the UE belongs, sends to the UE a number of the multicast group (such as a multicast group ID) where the UE belongs, encodes a data packet including the cyclic shift value offset information of the control channel by using the number of the multicast group where the UE belongs, and sends the encoded data packet to the UE so that the UE can use an identifier of the multicast group where the UE belongs to identify the cyclic shift value offset information sent by the network side device thereto.

S304: The UE generates a control signal according to the shift cyclic value, and sends the control signal.

At this time, the control signals generated by the UEs that obtain different cyclic shift value offset values are orthogonal and do not interfere with each other. Certainly, the control signal herein includes a physical uplink control channel signal.

Herein, based on the prior art, the formula for obtaining the cyclic shift value is modified to be the following formulas:

which include:

$${n}_{cs} ( {n}_{s} , l ) = \{ \begin{matrix}[ \begin{matrix}{n}_{cs}^{cell} ( {n}_{s} , l ) + \\ \begin{matrix}( \begin{matrix}{n}^{′} ( {n}_{s} ) \cdot {Δ}_{shift}^{PUCCH} + \\ ( {n}_{oc} ( {n}_{s} ) mod {Δ}_{shift}^{PUCCH} )\end{matrix} ) mod {N}^{′} + \\ {CS}_{offset}\end{matrix}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ {n}_{oc} ( {n}_{s} ) / 2\end{matrix} ) mod {N}^{′} + {CS}_{offset}\end{matrix} ] mod {N}_{sc}^{RB} , Extended CP\end{matrix} , \\ or \\ {n}_{cs} ( {n}_{s} , l ) = \{ \begin{matrix}[ \begin{matrix}\begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ ( {n}_{oc} ( {n}_{s} ) mod {Δ}_{shift}^{PUCCH} + {CS}_{offset} )\end{matrix} ) \end{matrix} \\ mod {N}^{′}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ {n}_{oc} ( {n}_{s} ) / 2 + {CS}_{offset}\end{matrix} ) mod {N}^{′}\end{matrix} ] mod {N}_{sc}^{RB} , Extended CP\end{matrix} , \\ or \\ {n}_{cs} ( {n}_{s} , l ) = \{ \begin{matrix}[ \begin{matrix}\begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ ( ( \begin{matrix}{n}_{oc} ( {n}_{s} ) + \\ {CS}_{offset}\end{matrix} ) mod {Δ}_{shift}^{PUCCH} )\end{matrix} ) \end{matrix} \\ mod {N}^{′}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ \frac{{n}_{oc} ( {n}_{s} )}{2 + {CS}_{offset}}\end{matrix} ) mod {N}^{′}\end{matrix} ] mod {N}_{sc}^{RB} , Extended CP\end{matrix} .$$

nₛ is a timeslot number, and a value range is 0 to 19; l represents a symbol number of a time domain, and each timeslot includes seven symbols; n_{cs}(nₛ,l) is a cyclic shift value; CS_{offset} is a cyclic shift offset value, a value range thereof is 0 to (max(Δ_{shift}^{PUCCH})−1), and (max(Δ_{shift}^{PUCCH})−1) represents the maximum value of Δ_{shift}^{PUCCH} minus one; n′(nₛ) is a logic resource number of the control signal; n_{oc}(nₛ) is an orthogonal mask value; mod is a modulus operation; Δ_{shift}^{PUCCH} is a cyclic interval of the cyclic shift value; in the same cell, values of n_{cs}^{cell}(nₛ, l), Δ_{shift}^{PUCCH}, N′, and N_{sc}^{RB} are the same; and n_{cs}^{cell}(nₛ,l) represents cell offset values at different cyclic moments. In a practical system, change rules of n_{cs}^{cell}(nₛ, l) values of different cells are usually different, and therefore interference between control signals sent by UEs of different cells varies at different moments, which reduces the occurrence probability of continuous strong interference; in other words, the interference is randomized. The UE may acquire a specific n_{cs}^{cell}(nₛ,l) value through a preset formula. Δ_{shift}^{PUCCH} represents a minimum interval of the cyclic shifts used in the control signal. For example, a total of 12 cyclic shift values exist; when Δ_{shift}^{PUCCH}=3, the interval between adjacent cyclic shift values is 3; in this case, only four of the 12 cyclic shifts can be used for transmitting control signals. The network side device may send signaling to the UE so as to configure the value of Δ_{shift}^{PUCCH}. N′ represents the number of cyclic shifts available to the control signal in a physical resource block (PRB, Physical Resource Block). For example, in an LTE system, if four of 12 cyclic shifts are used for transmitting other signals, the control signal can only use other 8 cyclic shift values, where the N′ is usually preset at the UE side. N_{sc}^{RB} represents the number of subcarriers in a PRB, which is equal to the total number of cyclic shifts in the LTE system, such as 12, where the N_{sc}^{RB} is usually preset at the UE side. A cyclic prefix (CP, Cyclic Prefix) is a common technology for reducing multipath channel fading. For example, the LTE system may flexibly choose to use a normal CP or an extended CP according to an application scenario, where the length of a CP in an extended CP solution is greater than that of a normal CP, hence having an enhanced reduction effect. In a TTI, a control signal needs to be designed in a different manner due to the different CP lengths. Therefore, normal CP and extended CP scenarios are subject to different design in the above formulas.

S305: The base station determines the cyclic shift values used by the UEs according to the cyclic shift value offset information cyclic shift information sent to the UEs, and detects, according to the cyclic shift values and through the nodes, the control signals sent by the UEs.

Therefore, the UE uses orthogonal physical resources to send control signals, hence enhancing the performance of the base station in detecting the control signals sent by the UEs.

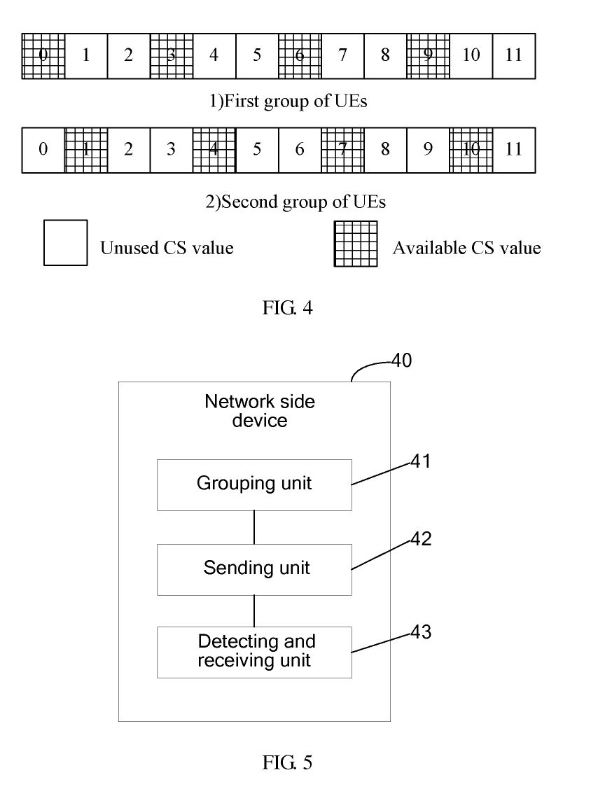

Specifically, it is assumed the DAS cell includes a node 3 and a node 4; the base station then groups the UEs within the cell. Certainly, the grouping herein is non-repeated grouping, so one UE will not be grouped into two groups. Then, the base station sends first CS offset information to a first group of UEs and sends second CS offset information to a second group of UEs through the node 3 and/or the node 4. For example, the first CS offset information sent to the first group of UEs includes a cyclic shift offset value 0, and the second CS offset information sent to the second group of UEs includes a cyclic shift offset value 1; in this way, the CS values used by UEs in different groups are different. As shown in FIG. 4, for example, when N_{sc}^{RB}=12 and Δ_{shift}^{PUCCH}=3, only four CS values can be used on a symbol. The CS offset information corresponding to the first group of UEs includes the following cyclic shift offset value: CS_{offset}=0; then CS values available to the first group of UEs (the finally calculated n_{cs}(nₛ,l) value) include 0, 3, 6, and 9; the CS offset information corresponding to the second group of UEs includes the following cyclic shift offset value: CS_{offset}=1; then CS values available to the second group of UEs (the finally calculated n_{cs}(nₛ,l) value) include 1, 4, 7, and 10 (which at least differ from the CS values of the first group of UEs by 1). In this manner, it is ensured that when different nodes use the same n_{CCE} value to send PDCCH (physical downlink control channel, physical downlink control channel) signals to UEs in different groups, the UEs in different groups use different CS values, so that the PUCCHs sent by the UEs are orthogonal. n_{CCE} is a physical resource number of the PDCCH, and a logic resource number of the PUCCH is: n′(nₛ)=n_{PUCCH}. In the LTE system, when a UE detects the PDCCH, the UE acquires the physical resource number of the PDCCH n_{CCE}, and therefore can acquire the logic resource number used for sending the PUCCH according to the preset formula (the acquiring process is the same for UEs in different groups within the same cell). Then the cyclic shift value is calculated according to the formula for acquiring the cyclic shift value in the above process. Therefore, it is realized that UEs in different groups (namely, UEs controlled by different nodes) within the same DAS cell use different CS values to send PDCCH signals, and do not interfere with each other.

As shown in FIG. 5, a network side device 40 provided in an embodiment of the present invention includes a grouping unit 41, a sending unit 42, and a detecting and receiving unit 43, where:

the grouping unit 41 is configured to group user equipments UEs within a distributed antenna system DAS cell in a non-repeated manner;

the sending unit 42 is configured to send different cyclic shift value offset information to UEs in different groups, so that the UEs generate control signals according to the cyclic shift value offset information; and

the detecting and receiving unit 43 is configured to determine cyclic shift values used by the UEs according to the cyclic shift value offset information, and detect the control signals sent by the UEs according to the cyclic shift values.

Alternatively, the network side device is a combination of a base station and multiple nodes.

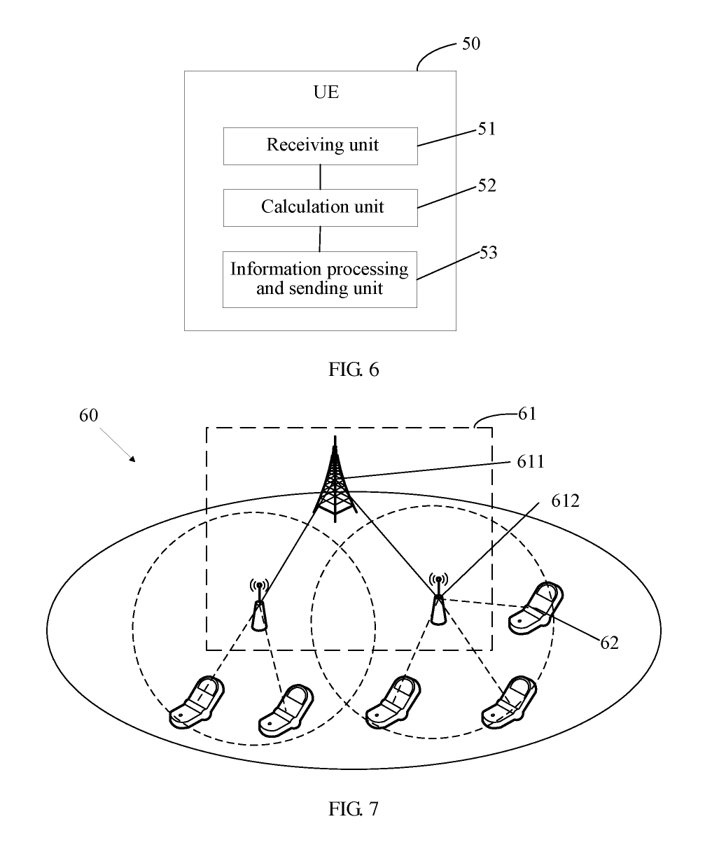

As shown in FIG. 6, a UE 50 provided in an embodiment of the present invention includes a receiving unit 51, a calculation unit 52, and an information processing and sending unit 53, where:

the receiving unit 51 is configured to receive cyclic shift value offset information used for generating a control signal;

the calculation unit 52 is configured to determine a cyclic shift value according to a cyclic shift offset value acquired from the cyclic shift value offset information; and

the information processing and sending unit 53 is configured to generate a control signal according to the cyclic shift value, and send the control signal.

Alternatively, the UE herein may be a mobile phone.

The device provided in this embodiment of the present invention enables UEs to use different cyclic shift values to generate control signals, so as to avoid that different UEs occupy the same physical resources to send control signals, and enhance performance of a network side device in detecting the control signals sent by the UEs.

Furthermore, alternatively, the grouping unit 41 is configured to detect mutual interference strength among signals received from the UEs within the DAS cell, and group the UEs within the distributed antenna system DAS cell in a non-repeated manner according to the mutual interference strength, where UEs with mutual interference strength exceeding a preset threshold value are grouped into different groups.

Alternatively, the sending unit 42 is configured to send different cyclic shift value offset information for controlling a physical uplink control channel to the UEs in different groups in a unicast or multicast manner.

Alternatively, the sending unit 42 is configured to send different cyclic shift value offset information for controlling a physical uplink control channel to the UEs in different groups by using RRC signaling and/or implicit signaling.

Alternatively, the receiving unit 51 is configured to receive the cyclic shift value offset information used for generating a control signal and sent by a corresponding node in a unicast manner or a multicast manner, where the control signal includes a physical uplink control channel signal.

The determining, by the calculation unit 52, the cyclic shift value according to the cyclic shift offset value acquired from the cyclic shift value offset information specifically, includes:

obtaining the cyclic shift value according to the following formulas:

$${n}_{cs} ( {n}_{s} , l ) = \{ \begin{matrix}[ \begin{matrix}{n}_{cs}^{cell} ( {n}_{s} , l ) + \\ \begin{matrix}( \begin{matrix}{n}^{′} ( {n}_{s} ) \cdot {Δ}_{shift}^{PUCCH} + \\ ( {n}_{oc} ( {n}_{s} ) mod {Δ}_{shift}^{PUCCH} )\end{matrix} ) mod {N}^{′} + \\ {CS}_{offset}\end{matrix}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ {n}_{oc} ( {n}_{s} ) / 2\end{matrix} ) mod {N}^{′} + {CS}_{offset}\end{matrix} ] mod {N}_{sc}^{RB} , Extended CP\end{matrix} , \\ or \\ {n}_{cs} ( {n}_{s} , l ) = \{ \begin{matrix}[ \begin{matrix}\begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ ( {n}_{oc} ( {n}_{s} ) mod {Δ}_{shift}^{PUCCH} + {CS}_{offset} )\end{matrix} ) \end{matrix} \\ mod {N}^{′}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ {n}_{oc} ( {n}_{s} ) / 2 + {CS}_{offset}\end{matrix} ) mod {N}^{′}\end{matrix} ] mod {N}_{sc}^{RB} , Extended CP\end{matrix} , \\ or \\ {n}_{cs} ( {n}_{s} , l ) = \{ \begin{matrix}[ \begin{matrix}\begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ ( ( \begin{matrix}{n}_{oc} ( {n}_{s} ) + \\ {CS}_{offset}\end{matrix} ) mod {Δ}_{shift}^{PUCCH} )\end{matrix} ) \end{matrix} \\ mod {N}^{′}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ \frac{{n}_{oc} ( {n}_{s} )}{2 + {CS}_{offset}}\end{matrix} ) mod {N}^{′}\end{matrix} ] mod {N}_{sc}^{RB} , Extended CP\end{matrix} .$$

nₛ is a timeslot number, and a value range is 0 to 19; l represents a symbol number of a time domain, and each timeslot includes seven symbols; n_{cs}(nₛ, l) is a cyclic shift value; CS_{offset} is a cyclic shift offset value, a value range thereof is 0 to (max(Δ_{shift}^{PUCCH})−1), and (max(Δ_{shift} ^{PUCCH})−1) represents a maximum value of Δ_{shift}^{PUCCH} minus one; n′(nₛ) is a logic resource number; n_{oc}(nₛ) is an orthogonal mask value; mod is a modulus operation; Δ_{shift}^{PUCCH} is a cyclic interval of the cyclic shift value; nₛ^{cell}(nₛ, l) is cell offset values of the cyclic shift value at different moments; N′ is the number of cyclic shift values available to the control signal in a physical resource block; N_{sc}^{RB} is the number of subcarriers in a physical resource block; in the same cell, values of n_{cs}^{cell}(nₛ,l), Δ_{shift}^{PUCCH}, N′, N_{sc}^{RB} are the same; and CP refers to a cyclic prefix, and a length of an extended CP is greater than that of a normal CP.

As shown in FIG. 7, a radio network system 60 provided in an embodiment of the present invention includes:

a network side device 61, configured to group user equipments UEs within a distributed antenna system DAS cell in a non-repeated manner; configured to send different cyclic shift value offset information to UEs in different groups, so that the UEs generate control signals according to the cyclic shift value offset information; and configured to determine cyclic shift values used by the UEs according to the cyclic shift value offset information, and detect the control signals according to the cyclic shift values through nodes; and

a UE 62, configured to receive cyclic shift value offset information used for generating a control signal; configured to determine a cyclic shift value according to a cyclic shift offset value acquired from the cyclic shift value offset information; and configured to generate a control signal according to the cyclic shift value.

Alternatively, the network side device 61 herein includes a base station 611 and a node 612 connected to the base station.

The radio network system provided in this embodiment of the present invention enables UEs to use different cyclic shift values to generate control signals, so as to avoid that different UEs occupy the same physical resources to send control signals, and enhance performance of a network side device in detecting the control signals sent by the UEs.

Those of ordinary skill in the art should understand that all or a part of the steps of the method according to the embodiments of the present invention may be implemented by a program instructing relevant hardware. The program may be stored in a computer readable storage medium. When the program is run, the steps of the method according to the embodiments of the present invention are performed. The storage medium may be any medium that is capable of storing program codes, such as a ROM, a RAM, a magnetic disk or an optical disk.

The foregoing descriptions are merely specific embodiments of the present invention, but not intended to limit the protection scope of the present invention. Any variation or replacement that can be easily thought of by persons skilled in the art without departing from the spirit of the present invention shall fall within the protection scope of the present invention. Therefore, the protection scope of the present invention is subject to the appended claims.

What is claimed is:

1. A radio network channel allocation method, comprising:
grouping user equipments (UEs) within a distributed antenna system (DAS) cell in a non-repeated manner;
sending different cyclic shift value offset information to UEs in different groups, so that the UEs generate control signals according to the cyclic shift value offset information and send the control signals; and
determining cyclic shift values used by the UEs according to the cyclic shift value offset information, and detecting the control signals sent by the UEs according to the cyclic shift values.

2. The method according to claim 1, wherein the grouping UEs within a DAS cell in a non-repeated manner comprises:
detecting mutual interference strength among signals received from the UEs within the DAS cell, and grouping the UEs within the DAS cell in a non-repeated manner according to the mutual interference strength, wherein UEs with mutual interference strength exceeding a preset threshold value are grouped into different groups.

3. The method according to claim 1, wherein the sending different cyclic shift value offset information of a control channel to UEs in different groups comprises:
sending different cyclic shift value offset information for controlling a physical uplink control channel to the UEs in different groups in a unicast or multicast manner.

4. The method according to claim 1, wherein the sending different cyclic shift value offset information of a control channel to UEs in different groups comprises:
sending different cyclic shift value offset information for controlling a physical uplink control channel to the UEs in different groups by using radio resource control (RRC) signaling and/or implicit signaling.

5. The method according to claim 1, wherein the control signal comprises a physical uplink control channel signal.

6. A radio network channel allocation method, comprising:
receiving cyclic shift value offset information used for generating a control signal;
determining a cyclic shift value according to a cyclic shift offset value acquired from the cyclic shift value offset information; and
generating a control signal according to the cyclic shift value, and sending the control signal.

7. The method according to claim 6, wherein the receiving cyclic shift value offset information used for generating a control signal comprises:
receiving the cyclic shift value offset information used for generating a control signal in a unicast or multicast manner.

8. The method according to claim 6, wherein the determining a cyclic shift value according to a cyclic shift offset value acquired from the cyclic shift value offset information specifically comprises:
obtaining the cyclic shift value according to the following formulas:
$${n}_{cs} ( {n}_{s} , l ) = \{ \begin{matrix}[ \begin{matrix}{n}_{cs}^{cell} ( {n}_{s} , l ) + \\ \begin{matrix}( \begin{matrix}{n}^{′} ( {n}_{s} ) \cdot {Δ}_{shift}^{PUCCH} + \\ ( {n}_{oc} ( {n}_{s} ) mod {Δ}_{shift}^{PUCCH} )\end{matrix} ) mod {N}^{′} + \\ {CS}_{offset}\end{matrix}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ {n}_{oc} ( {n}_{s} ) / 2\end{matrix} ) mod {N}^{′} + {CS}_{offset}\end{matrix} ] mod {N}_{sc}^{RB} , Extended CP\end{matrix} , \\ or \\ {n}_{cs} ( {n}_{s} , l ) = \{ \begin{matrix}[ \begin{matrix}\begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ ( {n}_{oc} ( {n}_{s} ) mod {Δ}_{shift}^{PUCCH} + {CS}_{offset} )\end{matrix} ) \end{matrix} \\ mod {N}^{′}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ {n}_{oc} ( {n}_{s} ) / 2 + {CS}_{offset}\end{matrix} ) mod {N}^{′}\end{matrix} ] mod {N}_{sc}^{RB} , Extended CP\end{matrix} , \\ or \\ {n}_{cs} ( {n}_{s} , l ) = \{ \begin{matrix}[ \begin{matrix}\begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ ( ( \begin{matrix}{n}_{oc} ( {n}_{s} ) + \\ {CS}_{offset}\end{matrix} ) mod {Δ}_{shift}^{PUCCH} )\end{matrix} ) \end{matrix} \\ mod {N}^{′}\end{matrix} ] mod {N}_{sc}^{RB} , Normal CP \\ [ \begin{matrix}{n}_{cs}^{cell} ( {n}_{s} , l ) + \\ ( \begin{matrix}{n}^{′} ( {n}_{s} ) \cdot {Δ}_{shift}^{PUCCH} + \\ \frac{{n}_{oc} ( {n}_{s} )}{2 + {CS}_{offset}}\end{matrix} ) mod {N}^{′}\end{matrix} ] mod {N}_{sc}^{RB} , Extended CP\end{matrix} ,$$
wherein nₛ is a timeslot number, and a value range is 0 to 19; l represents a symbol number of a time domain, and each timeslot comprises seven symbols; n_{cs}(nₛ, l) is a cyclic shift value; CS_{offset} is a cyclic shift offset value, a value range thereof is 0 to (max (Δ_{shift}^{PUCCH})−1), and (max(Δ_{shift}^{PUCCH})−1) represents a maximum value of Δ_{shift}^{PUCCH} minus one; n′(nₛ) is a logic resource number; n_{oc}(nₛ) is an orthogonal mask value; mod is a modulus operation; ΔP_{shift}^{PUCCH} is a cyclic interval of the cyclic shift value; n_{cs}^{cell}(nₛ,l) is cell offset values of the cyclic shift value at different moments; N′ is the number of cyclic shift values available to the control signal in a physical resource block; N_{sc}^{RB} is the number of subcarriers in a physical resource block; in the same cell, values of n_{cs}^{cell}(nₛ, l), Δ_{shift}^{PUCCH}, N′, N_{sc}^{RB} are the same; and P refers to a cyclic prefix, and a length of an extended CP is greater than that of a normal CP.

9. The method according to claim 6, wherein the control signal comprises a physical uplink control channel signal.

10. A network side device, comprising:
a grouping unit, configured to group user equipments (UEs) within a distributed antenna system (DAS) cell in a non-repeated manner;
a sending unit, configured to send different cyclic shift value offset information to UEs in different groups, so that the UEs generate control signals according to the cyclic shift value offset information and send the control signals; and
a detecting and receiving unit, configured to determine cyclic shift values used by the UEs according to the cyclic shift value offset information, and detect the control signals sent by the UEs according to the cyclic shift values.

11. The network side device according to claim 10, wherein the grouping unit is configured to detect mutual interference strength among signals received from the UEs within the DAS cell, and group the UEs within the DAS cell in a non-repeated manner according to the mutual interference strength, wherein UEs with mutual interference strength exceeding a preset threshold value are grouped into different groups.

12. The network side device according to claim 10, wherein the sending unit is configured to send different cyclic shift value offset information for controlling a physical uplink control channel to the UEs within different groups in a unicast or multicast manner.

13. The network side device according to claim 10, wherein the sending unit is configured to send different cyclic shift value offset information for controlling a physical uplink control channel to the UEs in different groups by using RRC signaling and/or implicit signaling.

14. The network side device according to claim 10, wherein the control signal comprises a physical uplink control channel signal.
